(19) United States
(12) Patent Application Publication
(10) Pub. No.: US 2005/0107075 A1
(43) Pub. Date: May 19, 2005

(54) Shuffle-play for a wireless communications device

(76) Inventor: Thomas David Snyder, Cary, NC (US)

Correspondence Address: COATS & BENNETT, PLLC, P O BOX 5, RALEIGH, NC, 27602, US

(21) Appl. No.: 10/716,212

(22) Filed: Nov. 18, 2003

(51) Int. Cl. H04M 3/00

(52) U.S. Cl. 455/418

(57) ABSTRACT

The present invention provides a system and method of selecting a complementary multi-media effect for activation in a wireless communications device. A user or service provider creates a picklist comprising a list of complementary multi-media effects available to the wireless communications device. A complementary multi-media effect from the picklist is automatically selected for activation upon the receipt of a predetermined event, such as an incoming call. Thereafter, the selected complementary multi-media effect is automatically changed to a new complementary multi-media effect that is also selected from the picklist. Upon the receipt of a subsequent predetermined event, the new selected complementary multi-media effect is activated. A processor within the wireless communications device or in an external network may perform selection of the complementary multi-media effects from the picklist.

### BACKGROUND

The present invention relates generally to wireless communications devices, and in particular, to the activation of one or more complimentary multi-media effects available to the wireless communications device.

Consumers often seek innovative features and new functionality when deciding on whether to purchase a wireless communications device. One especially popular feature allows a user to assign a melodic ring tone to a specific remote party's terminal. Upon receiving an incoming call, the user can identify the caller simply by listening to the ring tone. Also popular is the ability to play games, view images, video, and define various vibration and lighting patterns.

Of course, consumer interest in what was once new and innovative often wanes quickly. Thus, manufacturers and service providers sometimes struggle to keep abreast of consumer demand. Those that cannot get new features to market fast enough may find themselves losing market share. On the other hand, those that do may fail to realize sufficient capital to justify their investment in developing the functionality. Therefore, manufacturers and service providers would benefit if they could offer new and innovative features, functionality, and services based on existing infrastructure. Not only would this allow these entities to get features to market faster and cheaper, it would prolong an existing revenue stream as well as create the potential for new revenue streams.

### SUMMARY

The present invention provides a wireless communications device operable to “shuffle-play” complimentary multi-media effects selected from a picklist. As used herein, the picklist means a list that comprises one or more complimentary multi-media effects available to the wireless communications device. A complimentary multi-media effect comprises, for example, audio files, ring tones, vibrator patterns, games, images, video sequences, and lighting patterns.

In one embodiment, the wireless communications device comprises a transceiver, memory, and a processor to control the one or more complimentary multi-media effects. The processor is configured to play or activate a complimentary multi-media effect selected from the picklist upon the receipt of a predetermined event. Thereafter, the processor is configured to automatically change the selected complimentary multi-media effect to a new complimentary multi-media effect, also selected from the picklist, and play or activate the new complimentary multi-media effect upon receipt of a subsequent predetermined event. Selection of the complimentary multi-media effect from the picklist occurs without intervention from the user.

### BRIEF DESCRIPTION OF THE DRAWINGS

FIG. 1 illustrates a wireless communications device according to one embodiment of the present invention.

FIG. 2 is a perspective view of a wireless communications device according to an alternate embodiment of the present invention.

FIG. 3 illustrates a possible network configuration employed in one embodiment of the present invention.

FIG. 4 illustrates one exemplary method of creating a picklist according to one embodiment of the present invention.

FIG. 5A illustrates one exemplary method of one embodiment of the present invention.

FIG. 5B illustrates another exemplary method of an alternate embodiment of the present invention.

FIG. 6 illustrates yet another exemplary method of one embodiment of the present invention.

### DETAILED DESCRIPTION

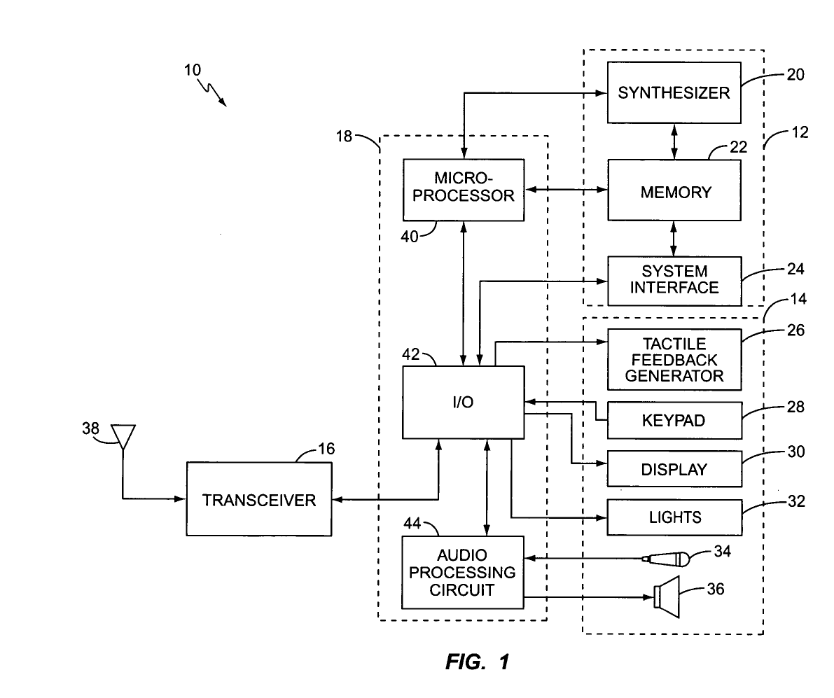

Referring now to FIG. 1, a block diagram of wireless communications device according to one embodiment of the present invention is shown therein, and indicated generally by the number 10. Device 10 comprises circuitry 12, a user interface 14, transceiver 16, and control circuitry 18. As shown in the figures, device 10 embodies a cellular telephone. The present invention is not, however, limited to a cellular telephone but may be embodied in other communication devices. For example, the present invention also contemplates satellite telephones, personal communication services (PCS) devices, personal data assistants (PDAs), palm-top computers, and the like.

Circuitry 12 comprises a synthesizer 20, memory 22, and a system interface 24. Synthesizer 20 may be, for example, a Musical Instrument Digital Interface (MIDI) synthesizer that synthesizes audio files for playback to a user of device 10. These audio files include, but are not limited to, polyphonic music used as ring tones. The information carried in the files may be information regarding a note to be played, when to change tones, volume, various instruments, and/or sounds to be played or synthesized, and how long to sustain a given note. Synthesizer 20, via built in hardware and/or software, reads these files and renders them as digital audio to the user.

Memory 22 represents the entire hierarchy of memory in device 10, including both random access memory (RAM) and read-only memory (ROM), and may be partitioned. Operating instructions and data required for operation of device 10 may be stored in a non-volatile partition accessible to the user. This portion of the memory, as will later be described, may also store picklists containing a list of one or more complimentary multi-media effects available to device 10. Other information, such as temporary data and/or instructions, may be stored in a volatile or temporary partition that is not directly accessible to the user. Memory 22 includes devices such as EPROM, EEPROM, and/or flash memory, and may be implemented as a discrete device, stacked device, or integrated with microprocessor 40.

System interface 24 facilitates the inter-connection of device 10 with one or more peripheral devices, such as a battery charger, a hands-free headset, an external computing device, a digital video camera, or external memory. Through system interface 24, users may charge the battery of device 10, exchange data with external peripheral devices, and control the operation of the external peripheral devices. Typically, system interface 24 comprises a “female” type connector that receives “male” type connectors from system plugs. However, alternate embodiments contemplate system interface 24 as a “male” type connector that receives corresponding “female” type system plugs.

User interface 14 comprises a tactile generator 26, a keypad 28, a display 30, lights 32, a microphone 34, and a speaker 36. Tactile generator 26 comprises an electric motor and generates tactile signals that can be sensed by the user upon the receipt of an incoming call. Additionally, tactile generator 26 may also be activated responsive to an alert, or to the play of a game stored in memory 22 of device 10. The user may specify a variety of varying patterns for the tactile generator 26 to follow when activated.

Keypad 28 includes an alphanumeric keypad, and optionally, other navigation controls. Keypad 28 allows the operator to dial numbers, enter commands, play games, and select options from various menus stored in memory 22. Display 30 displays information to the user including dialed digits, incoming caller identification, images, video sequences, call status information, menu options, and other service information. Lights 32 provide visual indications to the user, and may comprise backlighting for keypad 28 or display 30, for example.

Microphone 34 converts the user's speech into electrical audio signals, while speaker 36 converts audio signals into audible sounds for the user. Microphone 34 and speaker 36 send and receive signals to/from transceiver 16 via audio processing circuit 44. Transceiver 16 is coupled to an antenna 38 and is a fully functional cellular radio transceiver that operates according to standards well known in the art, including Global System for Mobile Communications (GSM), TIA/EIA-136, cdmaOne, cdma2000, UMTS, and Wideband CDMA.

Control circuitry 18 interconnects circuitry 12, user interface 14, and transceiver 16, and controls the operation of device 10. Control circuitry 18 comprises a microprocessor 40, an input/output circuit 42, and an audio processing circuit 44. Microprocessor 40 may be implemented as one or more microprocessors, and may be any suitable processor known in the art. This includes general purpose and special purpose microprocessors, as well as digital signal processors (DSPs). Microprocessor 40 controls the operation of device 10 according to programs stored in memory 22, and generates control signals to control one or more complementary multi-media features, such as lights 32, tactile generator 26, and ring tones stored as audio files in memory 22. As will be described later, microprocessor 40 is configured to select a complimentary multi-media effect from the picklist stored in memory 22.

Input/output circuit 42 interfaces microprocessor 40 with system interface 24, tactile generator 26, keypad 28, lights 30, audio processing circuit 44, and transceiver 16. Audio processing circuit 44 provides basic analog output signals to speaker 36 and accepts analog audio inputs from microphone 34. Thus, the user of device 10 may communicate to a remote party via transceiver 16, as well as hear ring tones rendered by Synthesizer 20, and other alerts or alarms.

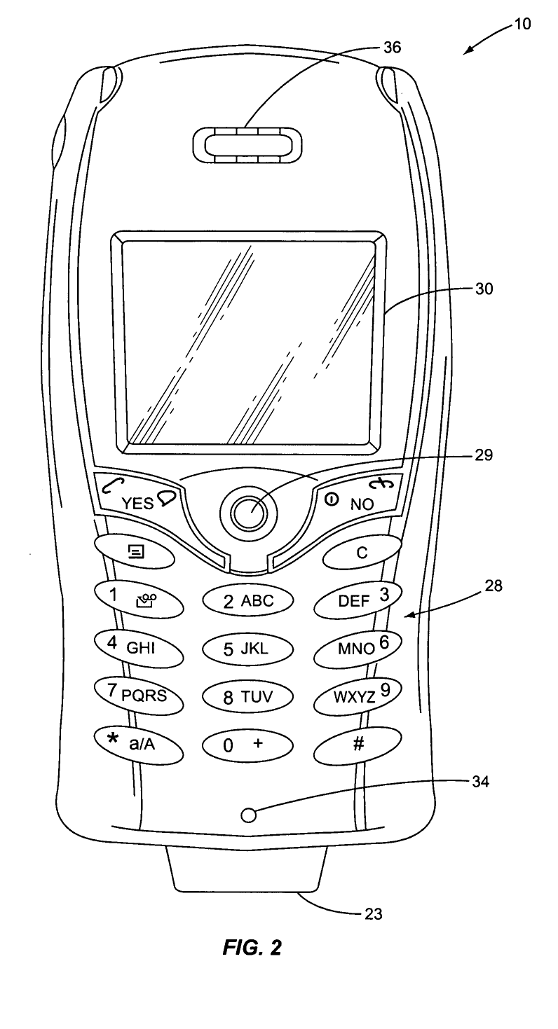

FIG. 2 illustrates device 10 as a mobile telephone. In this embodiment, device 10 also includes a joystick 29 and external memory 23. Joystick 29 allows the user to navigate and select items from a variety of menus stored in memory 22. External memory 23 is a peripheral device that connects to system interface 24, and provides additional memory storage for device 10.

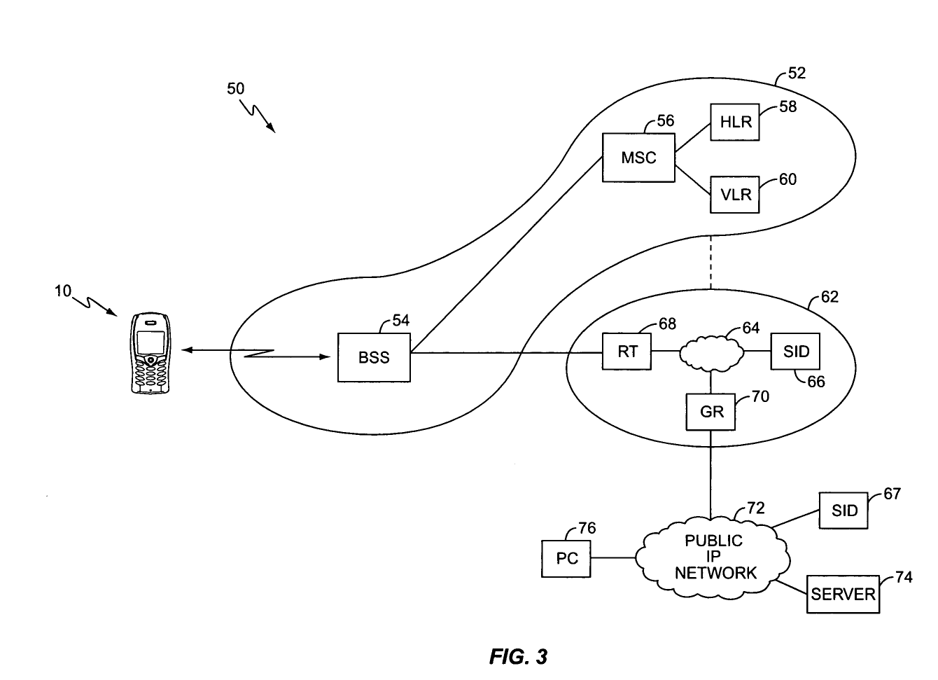

FIG. 3 illustrates a possible network configuration in which device 10 may operate. Communications network 50 may comprise a wireless network 52, and an intermediate network 62. Wireless network 52 comprises a base station system (BSS) 54 having one or more base stations, a mobile service center (MSC) 56, a home location register (HLR) 58, and a visitors location register (VLR) 60. Other components may or may not exist depending upon the configuration of wireless network 52. The operation of wireless network 52 is well known in the art, and thus, is not discussed in any detail here. It is sufficient, however, to note that HLR 58 and VLR 60 may store one or more picklists in addition to their typical compliment of subscriber data.

Intermediate network 62 may be distinct from or integrated with wireless network 52, and includes a local area network 64, a subscriber database (SID) 66, a router 68, and a gateway 70. Local area network 64 represents any type of network known in the art capable of providing a communications pathway between wireless network 52, SID 66, router 68, and gateway 70. Like wireless network 52, the details of intermediate network 62 are well known and not discussed in any detail. It is sufficient to understand that picklists may be stored on SID 66.

Gateway 70 provides a connection to a server 74 and/or a PC 76 via a public IP network 72, for example, the Internet. This allows the user of device 10 to communicate with a remote party, as well as access data stored on SID 67, server 74, and/or PC 76. Like intermediate network 62, SID 67, server 74, and/or PC 76 may comprise subscriber data, such as picklists, that may be downloaded to device 10.

As previously stated, the present invention may “shuffle-play” a complimentary multi-media effect without user intervention by playing or activating a complimentary multi-media effect selected from a picklist. The selection order of the complimentary multi-media effect from the picklist may be random, or predetermined. Once an effect is selected, the picklist may be “shuffled” or re-sequenced and another effect chosen. One or more picklists may be created and stored on device 10, or alternatively network 50, each containing a list of one or more complimentary multi-media effects available to device 10. Shuffling the order of the complimentary multi-media effects in the list helps to ensure diversity of selection.

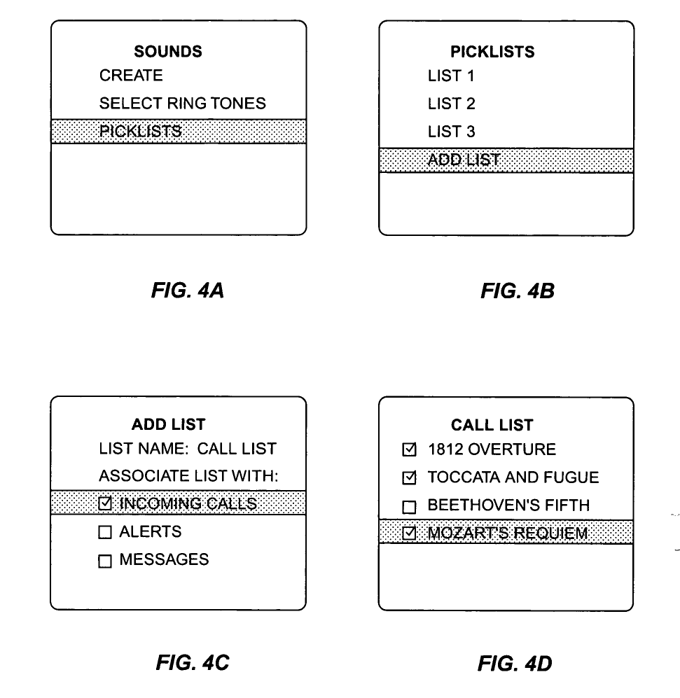

In one embodiment of the present invention, seen in FIGS. 4A-4D, the user may create the picklists directly on device 10 by manipulating joystick 29 or keypad 28 to navigate a menu system. In FIGS. 4A-4D, the user selects the “PICKLISTS” option to invoke a menu that lists one or more picklists. To edit or review an existing list, the user simply selects the name of the list to invoke a display containing all the effects assigned to that particular list. To create a new list, the user simply selects “ADD LIST” to invoke the Add List menu and enters a list name, which in this example is “Call List.” The user then associates the picklist with a category of events that may occur. In FIG. 4C, the user associates the picklist with incoming calls by selecting the “INCOMING CALLS” item. This invokes a list of available ring tones stored in memory 22 of device 10 from which the user may choose. The user then selects one or more of the available ring tones using joystick 29 or keypad 28. In FIG. 4D, the user has selected “1812 OVERTURE,” “TOCCATA AND FUGUE,” and “MOZART'S REQUIEM” for inclusion into the picklist. The picklist is then stored in memory 22, or alternatively, external memory 23.

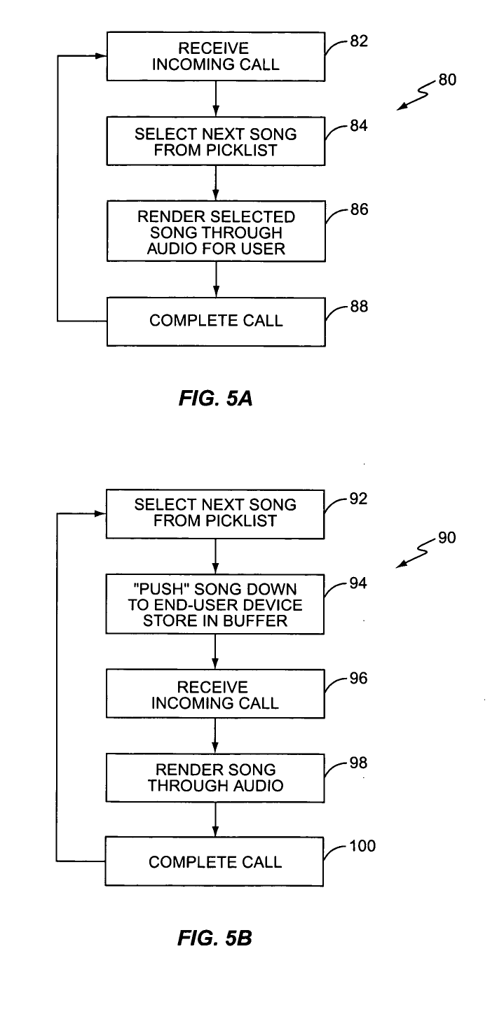

FIG. 5A is a flow diagram of one possible method 80 of the present invention. Upon the receipt of a first incoming call (box 82), microprocessor 40 selects one of the ring tones from the “Call List,” for example, “1812 OVERTURE,” (box 84), and controls Synthesizer 20 to render the selected ring tone as audio through speaker 36. As stated above, microprocessor 40 may select the ring tone at random or in a predetermined order. The user answers the call and communicates with the remote party until completion (box 88). Upon receipt of a second incoming call (box 82), microprocessor 40 changes the selected ring tone from “1812 OVERTURE” to a new selected ring tone (box 84). This change is accomplished automatically by microprocessor 40 without intervention from the user. In this example, microprocessor 40 selects “MOZART'S REQUIEM,” but may have just as easily selected “TOCCATA AND FUGUE.” Synthesizer 20 then renders the new selected ring tone as audio through speaker 36.

As can be inferred from method 80, microprocessor 40 may change the ring tone to a new selected ring tone upon the receipt of each incoming call. The selection may be random, or it may be according to a predetermined order chosen by the user. Alternatively, however, the present invention may also change ring tones upon occurrence of other predetermined events as well. By way of example, the user may decide to change selected ring tones only upon receipt of every n^{th} call, such as every 5^{th}, or may decide to change ring tones only at predetermined times.

In an alternate embodiment of the present invention illustrated in FIG. 5B, the picklists may be created by the user or a service provider, and stored on one or more of the components of network 50. In this method 90, the network entity, for example, HLR 58, VLR 60, SID 66, 67, or server 74, selects a ring tone from the picklist (box 92) designated as being associated with incoming calls. The network entity pushes the selected ring tone audio file to device 10, which subsequently stores the file in memory 22 or external memory 23 (box 94). Then, the network sends the incoming call to the user (box 96), Synthesizer 20 renders the selected ring tone as audio through speaker 36 (box 98), and the user completes the call (box 100). The network entity that selected the ring tone will then select a new ring tone and push it to device 10 upon receipt of a subsequent incoming call.

Storing the ring tone audio files on the network in this manner saves memory storage in device 10; however, sending the complete audio file may result in delaying call completion and use up bandwidth. To prevent this, the network entity may simply send an ID to device 10 that identifies the selected ring tone stored in memory 22 or 23.

FIGS. 4-5 illustrate the present invention using ring tones as a complimentary multi-media effect. However, those skilled in the art will readily appreciate that this is merely for illustrative purposes, and the present invention actually contemplates creating picklists containing many different types of complimentary multi-media effects. That is, the user may also create picklists that list vibrator patterns, lighting patterns, games, images, or video sequences, or any combination thereof, and associate each list with a group of events such as alerts, e-mail messages, text and/or voice messages, time, alarms, or pages. For example, a picklist could designate random background music and/or vibrating patterns to be activated at certain intervals of a gaming session. Various lighting patterns may be activated responsive to alerts or received messages. Microprocessor 40 in device 10 could further be configured to shuffle each of the items in the picklists after each selection or prior to each occurrence of a predetermined event.

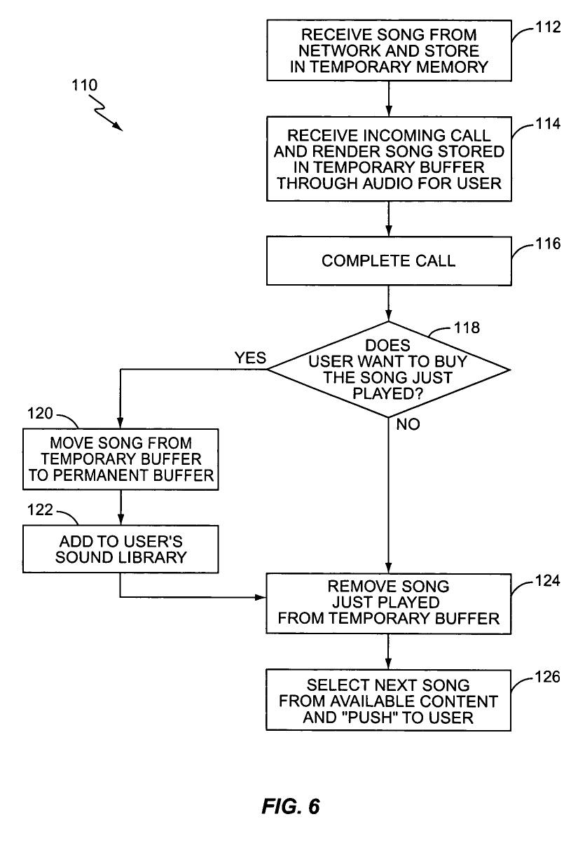

Another embodiment of the present invention is shown in FIG. 6. This embodiment provides the user with a broader range of effects from which to choose, and generates a potential revenue stream for the operator(s) of network 50 and/or the components therein. In method 110 of FIG. 6, device 10 receives an audio file representing a ring tone from the network 50, and stores it in a volatile partition in memory 22 or external memory 23 (box 112). The file may be selected from a picklist created by network operators and downloaded to device 10. Device 10 receives the incoming call, and microprocessor 40 signals Synthesizer 20 to render the file as audio through speaker 36 (box 114).

Once the call is complete (box 116) the user is provided with a choice to purchase the audio file just played (box 118). If the user chooses to purchase the file, microprocessor 40 moves the audio file from the volatile partition to the non-volatile partition (box 120), and adds the file to the user's sound library (box 122). The user may then return to the exemplary menu system in FIG. 4 and add the purchased audio file to one or more picklists. Alternatively, if the user chooses not to purchase the file, microprocessor 40 removes the file from the volatile partition completely (box 124), and selects a new ring tone to push to the user.

The partitioning of memory 22 and/or external memory 23 may be done by the user, or may be pre-configured. That is, the user may decide how much memory should be dedicated to store “owned” complimentary multi-media effects, and how much should be dedicated as temporary storage. Of course, the user would have very little, if any, control over the content stored in the temporary volatile partition to protect the interests of the network operators pushing the content to the user. However, the user would retain control over the non-volatile partition. Further, the audio files sent from the network may be sent to and stored in device 10 in advance of any incoming calls. This would prevent delays, as the downloaded audio file would already exist in device 10.

As those skilled in the art will understand, the embodiment of FIG. 6 is not limited to the purchase of ring tones responsive to an incoming call, but may be extended to include the download and purchase of games or other complimentary multi-media effects. The picklists created by the network operators may be targeted to users according to their preferences, and further, may be selected randomly, according to a predetermined order, or shuffled prior to/after each selection.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1. A method of selecting a complementary multi-media effect in a wireless communications device comprising:
creating a picklist comprising a plurality of complementary multi-media effects available to the wireless communications device;
selecting a complementary multi-media effect from the picklist for activation upon a first predetermined event; and
automatically changing the selected complementary multi-media effect to a new selected complementary multi-media effect without user intervention for activation upon a second predetermined event, wherein the new complementary multi-media effect is selected from the picklist.

2. The method of claim 1 wherein one of the first predetermined and second predetermined events comprises the receipt of an incoming call.

3. The method of claim 1 wherein one of the first predetermined and second predetermined events comprises the receipt of an alarm.

4. The method of claim 1 wherein one of the first predetermined and second predetermined events comprises the receipt of a text message.

5. The method of claim 1 wherein one of the first predetermined and second predetermined event comprises the receipt of an e-mail message.

6. The method of claim 1 wherein one of the first predetermined and second predetermined event comprises the receipt of a new voice message.

7. The method of claim 1 wherein one of the first predetermined and second predetermined events comprises the receipt of a page.

8. The method of claim 1 wherein one of the first predetermined and second predetermined events comprises the start of a gaming session.

9. The method of claim 1 wherein the picklist comprises a list of audio files.

10. The method of claim 1 wherein the picklist comprises a list of tactile function generator patterns.

11. The method of claim 1 wherein the picklist comprises a list of lighting patterns.

12. The method of claim 1 wherein the picklist comprises a list of images.

13. The method of claim 1 wherein the picklist comprises a list of video sequences.

14. The method of claim 1 wherein the picklist comprises a combination of at least two complementary multi-media effects.

15. The method of claim 1 wherein the picklist is stored in memory on the wireless communications device.

16. The method of claim 1 wherein the picklist is stored in memory external to the wireless communications device.

17. The method of claim 16 wherein the memory external to the wireless communications device comprises a server communicatively linked to the wireless communications device.

18. The method of claim 17 further comprising transmitting the new selected complementary multi-media effect to the wireless communications device over a wireless communications network.

19. The method of claim 18 further comprising partitioning memory in the wireless communications device into first and second partitions, and temporarily storing the new selected complementary multi-media effect in the first partition.

20. The method of claim 19 further comprising moving the new selected complementary multi-media effect from the first partition to the second partition if the user chooses to save the new selected complementary multi-media effect.

21. The method of claim 19 further comprising removing the new selected complementary multi-media effect from the first partition if the user chooses not to save the new selected complementary multi-media effect.

22. The method of claim 1 wherein creating a picklist comprises defining the activation order for each complementary multi-media effect in the picklist.

23. The method of claim 1 wherein automatically changing the selected complementary multi-media effect comprises randomly selecting the new selected complementary multi-media effect from the picklist.

24. The method of claim 1 wherein automatically changing the selected complementary multi-media effect to a new complementary multi-media effect comprises selecting the next selected complementary multi-media effect to be activated from the ordered picklist.

25. The method of claim 1 wherein automatically changing the selected complementary multi-media effect to a new complementary multi-media effect comprises shuffling the picklist after each predetermined event occurs, and selecting the new selected feature from the shuffled picklist.

26. The method of claim 1 wherein one of the first predetermined and second predetermined events occurs on every n^{th} predetermined event, wherein n is greater than 0.

27. The method of claim 1 wherein one of the first predetermined and second predetermined events occurs at a predetermined time.

28. A method of playing a ring tone in a wireless communications device comprising:
creating a picklist comprising a plurality of available ring tones;
playing a selected ring tone from the picklist upon receipt of an incoming call; and
automatically changing the selected ring tone to a new selected ring tone when a predetermined event occurs, wherein the new selected ring tone is selected from the picklist without user intervention.

29. The method of claim 28 wherein automatically changing the selected ring tone comprises randomly selecting a new ring tone from the picklist.

30. The method of claim 28 wherein creating a picklist comprises defining the order in which each ring tone is to be played.

31. The method of claim 30 wherein automatically changing the selected ring tone comprises selecting the next ring tone to be played from the ordered picklist.

32. The method of claim 28 wherein changing the selected ring tone comprises shuffling the picklist after each predetermined event occurs, and selecting a new ring tone from the shuffled picklist.

33. The method of claim 28 wherein the predetermined event occurs at a predetermined time.

34. The method of claim 28 wherein the predetermined event occurs upon receipt of every n^{th} call where n is greater than 0.

35. The method of claim 28 wherein the predetermined event is the receipt of a second incoming call.

36. The method of claim 28 wherein the predetermined event is the receipt of an alarm.

37. The method of claim 28 wherein the predetermined event is the receipt of a page.

38. The method of claim 28 wherein the predetermined event is the receipt of a voice mail message.

39. The method of claim 28 wherein the predetermined event is the receipt of a text message.

40. The method of claim 28 wherein the predetermined event is the receipt of an e-mail message.

41. The method of claim 28 wherein the predetermined event is the start of a gaming session.

42. The method of claim 41 further comprising automatically changing the selected ring tone to a new ring tone during game play.

43. The method of claim 28 further comprising storing the picklist in memory in the wireless communications device.

44. The method of claim 28 further comprising storing the picklist in memory external to the wireless communications device.

45. The method of claim 44 wherein storing the picklist in memory external to the wireless communications device comprises storing the picklist in a server communicatively linked to the wireless communications device.

46. The method of claim 45 wherein automatically changing the selected ring tone comprises selecting a new ring tone from the picklist stored on the server.

47. The method of claim 46 further comprising transmitting the new ring tone to the wireless communications device over a wireless communications network.

48. The method of claim 47 further comprising storing the new ring tone in memory in the wireless communications device and playing the new selected ring tone when the predetermined event occurs.

49. A method of activating a complementary multi-media effect in a wireless communications device comprising:
creating a picklist comprising a plurality of complementary multi-media effect available to the wireless communications device; and
shuffle-playing a complementary multi-media effect selected from the picklist.

50. The method of claim 49 wherein the shuffle-playing comprises automatically changing a selected complementary multi-media effect to a new selected complementary multi-media effect for activation upon a predetermined event, wherein the new selected complementary multi-media effect is selected from the picklist without user intervention.

51. A wireless communications device comprising:
a transceiver;
a memory; and
a processor configured to shuffle-play a complementary multi-media effect selected from a picklist comprising a plurality of complementary multi-media effect available to the wireless communications device, wherein the complementary multi-media effect is selected without user intervention.

52. The device of claim 51 further comprising a plug-in accessory that mates with a system interface connector on the wireless communications device.

53. A wireless communications network comprising;
a base station system to communicate with a mobile terminal; and
a processor communicatively linked to the base station system and the mobile terminal and configured to activate a complementary multi-media effect selected from a picklist.

54. The network of claim 53 wherein the base station system transmits the selected complementary multi-media effect to the mobile terminal for activation upon a predetermined event.

55. The network of claim 54 wherein the base station system transmits the selected complementary multi-media effect to the mobile terminal along with the predetermined event.
